(19) United States
(12) Patent Application Publication
(10) Pub. No.: US 2016/0063878 A1
(43) Pub. Date: Mar. 3, 2016

(54) COURSE CUSTOMIZER

(71) Applicant: Apollo Education Group, Inc., Phoenix, AZ (US)

(72) Inventors: Sudhakar Subashchandrabose, San Jose, CA (US); Anil Maipady, San Jose, CA (US); Shridar Navanageri, Sunnyvale, CA (US); Narender Vattikonda, San Jose, CA (US); Raghavendra Reddy, Sunnyvale, CA (US)

(21) Appl. No.: 14/473,382

(22) Filed: Aug. 29, 2014

(51) Int. Cl. G09B 5/12

(52) U.S. Cl. CPC G09B 5/12

(57) ABSTRACT

Techniques for providing customized learning material for a particular course so that each student can learn efficiently and effectively based on their own skills and depth of knowledge in the particular subject. The system allows customization of a path through the course material by setting waypoints. Each waypoint corresponds to a particular position within the course material. By setting multiple waypoints, a user can create a customized path through the course material. The user can further specify, for each waypoint, the level of detail of the course material presented to the user. By following the sequence of waypoints, the system can automatically present the course material via a course player to the user in the order the user prefers.

### CROSS-REFERENCE TO RELATED APPLICATIONS; BENEFIT CLAIM

This application is related to copending application Ser. No. 14/167,821, titled “Resource Resolver”, filed Jan. 29, 2014, the entire contents of which is hereby incorporated by reference as if fully set forth herein.

### FIELD OF THE INVENTION

The present invention relates to customizing the order and level of detail of educational course content.

### BACKGROUND

Many people would benefit from additional education, but are not able to attend traditional institutions of learning. To serve people with such circumstances, learning institutions make education opportunities available online, via the Internet. Putting education opportunities online allows these opportunities to be accessed by a greater number of students than are able to attend classes at a traditional campus.

Learning institutions spend valuable resources creating learning material designed to educate students effectively. However, learning material designed for a large audience may not be effective for each student because each student may have different preferred methods of learning. For instance, some students learn most effectively through video lectures where they can see the material as well as listen to the instructor, whereas other students may learn most effectively by only listening to the lecture, without video or by simply reading a summary of the lecture.

Another scenario where students may not be efficiently learning is when the level familiarity of the subject matter varies between students. For instance, if the course is related to accounting and one student is very familiar with accounting because he has previously taken economics courses, then his learning is inefficient when his accounting course spends two weeks on introductory material already familiar to him. However, there may be other students who are not as familiar with accounting and those two weeks spent on introductory material may be very beneficial to their learning. Therefore courses created for a large audience rarely suits every students' needs.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings of certain embodiment in which like reference numerals refer to corresponding parts throughout the figures:

FIG. 1 illustrates a flow diagram of the method for customizing a course by modifying a sequence of waypoints or by modifying the level of detail for particular course material referenced by one or more waypoints.

FIG. 2 illustrates an embodiment of user profile configuration for a particular course, where a user may create a custom profile by adding, deleting and moving waypoints from the default profile.

FIG. 3 illustrates an embodiment of the system structure and the interaction between the different elements of the course player.

FIG. 4 illustrates an example computer system that may be specifically configured to perform various techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In order to make learning more effective, techniques are provided for customizing a learning path through course material of a particular course so that each student can learn efficiently and effectively based on their own skills and depth of knowledge in the particular subject. Customizing a path through the course material is accomplished by setting waypoints. A waypoint corresponds to a particular position within the course material. By setting multiple waypoints, a user can create a customized path through the course material. The user can further specify, for each waypoint, the level of detail of the course material presented to the user.

By following the sequence of waypoints, the system can automatically present the course material via a course player to the user in the order the user prefers. This customized path can be defined as a path through the course material that either: 1) skips at least one or more portions of the course material, 2) specifies a presentation order of the course material that differs from the default order, or 3) specifies presentation of a least a portion of the course material at a level of detail that differs from the particular level of detail of the section that corresponds to the portion.

### A Course

A course is defined as a unit of teaching of an individual subject that lasts for a specified term. A course is made up of course material including, but not limited to, recorded lectures, reading assignments, problem worksheets, and testing material. For instance, an online course entitled Financial Accounting-349 may be a course that teaches students the conceptual framework of accounting as it applies to running a business. The course materials associated with Financial Accounting-349 may include a series of online recorded lectures, online reading material, problem sets that the student must complete, and online quizzes or exams. The course may be divided into sections. Each section may highlight a particular topic or exercise within the course and may be made up of one or more different course materials. For instance, a section entitled “Write-downs for businesses” may include one or more lectures, assigned reading, and problem exercises.

In one embodiment, a course author organizes the course sections and the course materials. The purpose of organizing the course is to create a preset navigation path by which students are meant to consume the course material. Without setting the preset navigation path, students would not know the order in which the material should be consumed. This preset navigation path acts as a template for the course and can be later customized by faculty, students, and/or the system itself.

### Waypoints

The preset navigation path consists of a series of waypoints within the course material. A waypoint is defined as a reference point in the course material. Using a series of waypoints, the system can navigate from one reference point in the course materials to the next reference point without having to ask the user which course material he wishes to view next. For instance, the present path may include navigating from Lectures 1-3 and then directly to Reading assignments 1-3 before presenting the user with Quiz 1.

In an embodiment, a waypoint is a pointer that provides information on: 1) what content to deliver, 2) the order in which the content is to be delivered relative to other waypoints, and 3) metadata containing which format and level of detail is to be delivered to the course player. A pointer may define one or more pieces of course material. For instance, a particular waypoint may point to course material labeled Lecture 1 in the series of lectures for the course. This means that when the system reads this particular waypoint, it will request Lecture 1 material and present Lecture 1 to the student. Other embodiments of the pointer may point to a series of lectures such as a subset of Lectures 1-3. In this case, the system will request and then play Lectures 1-3 in order.

The play order defined in the waypoint is used to determine when the referenced course material is to be played. For instance, if the waypoint described above had its play order set to number six, then the course player would only play Lecture 1 after all the course material referenced by waypoints with play orders of one through five are played first.

The waypoint stores metadata defining 1) the available presentation formats, 2) the user's preferred formats, and 3) level of detail for the referenced course material. Presentation format categories include, but are not limited to, video playback, audio/video playback, audio only playback, and text presentation. The metadata stored in the waypoint includes which presentation formats are available for each referenced course material. For instance, Lecture 1 may be available in all three formats, audio/video, audio only, and text. However, another waypoint may reference Quiz 1, which requires the user to interact using a mouse. In this case the metadata in that particular waypoint would indicate that video and audio/video, where a mouse is connected to the player, are the only available presentation formats.

The user's preferred presentation formats are stored in the waypoint metadata. Embodiments of user preferences may include a keeping track of the user's preferred presentation formats for various pieces of course material. For instance, if a user prefers audio/video formats for past lectures, then the waypoint would store the preference for audio/video when a lecture is referenced. Embodiments of determining user preference include, but are not limited to, the user manually inputting in their preference for various course material formats and the system automatically determining the user's preference based on historical format data from the user's prior courses.

The stored metadata in the waypoint also includes the level of detail to be presented to the user. The level of detail corresponds to how much detail from the course material is presented to the user. Embodiments of the level of detail may include, but are not limited to, a sliding scale starting from the minimal level of detail, where the user only sees topic headings, to the maximum level of detail where the user is presented with the course material for the particular waypoint. For instance, if the course author sets the level of detail for Reading Assignment 1 to “quick review”, then the course player would present Reading Assignment 1 to the user at a level of detail equivalent to the user only seeing the headings and summaries for each heading. However, if the course author sets the level of detail to “full”, then the user is presented with all the information stored within Reading Assignment 1. The course author initially sets the level of detail during course creation. The level of detail of the course material is set at course creation is referred to herein as the “default” level of detail.

A default profile is the preset navigation path created by the course author, which is defined as the default sequence of waypoints for navigating through the course material. This default profile can be customized by other users such as other faculty, students, or automatically by the system itself.

### Users

Profile customization of a given course may be performed by various users. A user includes, but is not limited to, the course author, various faculty members, and students. After the course author has created the default profile for the course, the author may additionally create custom profiles that cater to students with varying levels of experience. For instance, for a course entitled “Development Levels of Mathematical Thinking”, the author or a faculty member may create an advanced profile for students that are already familiar with the basics of this course. The advanced profile may skip waypoints that reference introductory material, and lower the level of detail for waypoints that reference problem assignments. Alternatively, the author or a faculty member may also create a beginner profile for students that are not familiar with any of the material in the course. One embodiment of the beginner profile increases the level of detail for one or more waypoints, provided that the default level of detail was not previously set to the maximum level of detail. Other embodiments of a customized beginner profile may include repeating waypoints that refer to problem sets or reading assignments as a way to reinforce the material to the student. Other users, such as faculty members and students, may create customized profiles by the same methods as described above.

### Customizing a Course

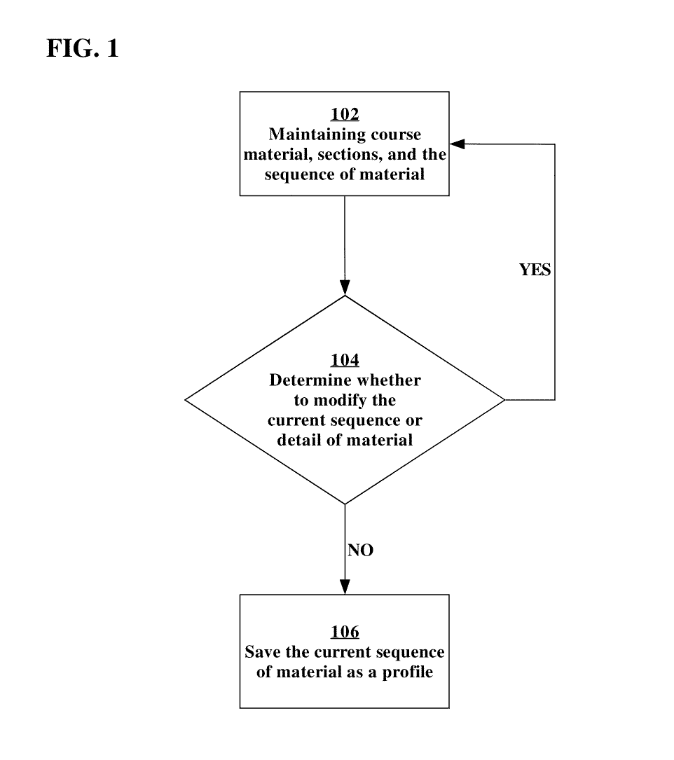

FIG. 1 is a flow diagram that depicts the overall process by which a user customizes a course by modifying the sequence of waypoints or by modifying the level of detail for particular course material referenced by one or more waypoints. At step 102, the system maintains course material for a particular course and the user reviews the course material and its sequence of waypoints. At step 104, the user determines whether to modify the course material. Embodiments of modifying the course material include, but are not limited to: 1) changing the play order of one or more waypoints, 2) adding or omitting one or more waypoints to and from the sequence, and 3) changing the level of detail for one or more waypoints. If the user modifies the current sequence of waypoints or the level of detail, then system reverts back to step 102, where the user reviews the course material and its sequence of waypoints. If the user does not modify the current sequence of waypoints or level of detail, then at step 106, the system saves the current sequence of waypoints as a profile.

Changing the play order of one or more waypoints in the sequence of waypoints, creates a customized profile that differs from the default profile originally created by the course author. For example, if the default profile includes a sequence of waypoints as:

1. Lecture 1

2. Reading Assignment 1

3. Simulation Activity 1

4. Week 1 Quiz

Then if the user changes the play order to the following sequence:

1. Lecture 1

2. Simulation Activity 1

3. Reading Assignment 1

4. Week 1 Quiz

By changing the play order of the Simulation Activity 1 and the Reading Assignment 1, the user creates a new customized profile that differs from the default profile.

Other embodiments of creating a custom profile include adding or omitting one or more waypoints from the default profile. For instance in the previous example, if the user deletes the Simulation Activity 1, resulting in the following path:

1. Lecture 1

2. Reading Assignment 1

3. Week 1 Quiz

The user creates a new custom profile because the play order of Week 1 Quiz changed from “4” to “3”. Therefore the play order of one or more waypoints has been altered from the default profile. Similarly, if the user adds one or more waypoints to the default profile, then the waypoints after the newly added waypoint would have their respective play orders increased, resulting in a customized profile. Embodiments of adding a new waypoint include the user creating a custom waypoint that either references new course material, or references a point in the course material that was not previously referenced by another waypoint. For instance, if a user creates a waypoint that references the second half of Reading Assignment 1, then the user has created a new waypoint that when processed, will begin playing at the second half of Reading Assignment 1.

Another embodiment of a customized profile includes changing the default level of detail for one or more waypoints in the default profile. By changing the level of detail for a particular waypoint, the user changes what is presented to him during playback. For instance, if the default level of detail for the specific waypoint, Reading Assignment 1, is set to “Full” and the user changes the level of detail for that specific waypoint to “Summary only”, then the course player presents the user with only the section headings and the associated summary paragraphs as opposed to the entire text for Reading Assignment 1. By changing the level of detail of one or more waypoints the user creates a customized profile because what is presented to the user during playback differs from the default profile.

Embodiments for changing the level of detail for particular course material referenced by a waypoint include, but are not limited to, manipulating a slider on a user interface for the current profile, selecting the appropriate radio button for the desired level of detail, and a dropdown menu where the user may choose the desired level of detail for that particular course material referenced by that waypoint.

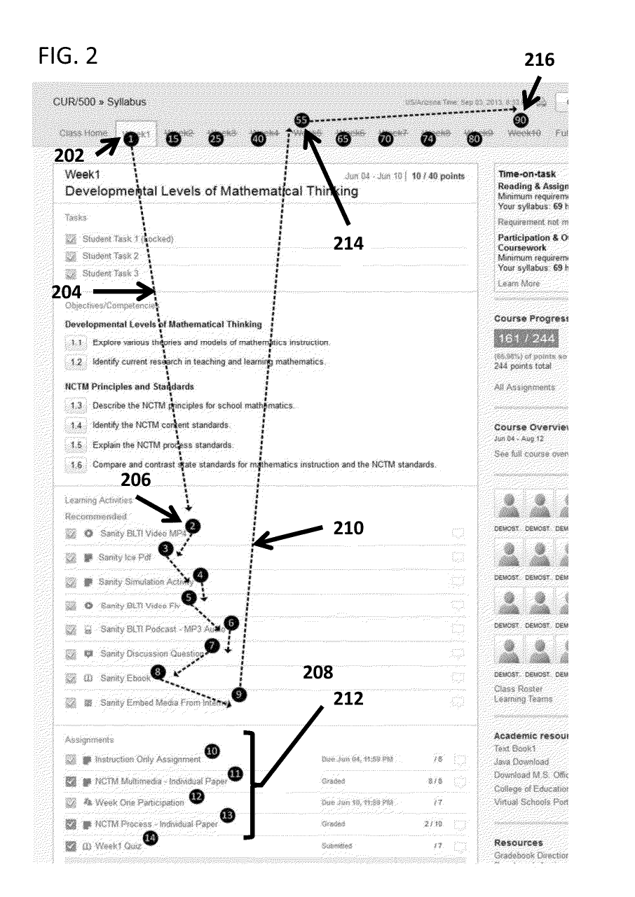

FIG. 2 is an embodiment of user profile configuration for a particular course, where a user may create a custom profile by adding, deleting and moving waypoints from the default profile. Each waypoint defined by the default profile is referred to herein as a “preset waypoint”. The preset waypoints in FIG. 2 are marked with a black circle and a number within the circle used as an identifier for the particular waypoint. In one embodiment, the waypoint identifier number corresponds to the play order specified in the preset navigation path. Waypoint-1 202 is the first preset waypoint and has a number “1” in the circle. Connector line 204 is an arrow marking the current path from Waypoint-1 202 to the next waypoint, Waypoint-2 206. Connector line 204 indicates that after Waypoint-1 202 is played by the course player, the course player will then progress to Waypoint-2 206. Waypoint-1 202 is the first waypoint because there is no connector line to denote a preceding waypoint. From Waypoint-2 206 connector lines are shown connecting the subsequent preset waypoints together to Waypoint-9 208. From Waypoint-9 208 the Connector line 210 connects Waypoint-9 208 to Waypoint-55 214. This means that after the course player plays the course material referenced by Waypoint-9 208, the course player will skip to the course material referenced by Waypoint-55 214. Preset waypoints “10 through 14” 212 have been omitted by the user because there is no connector line connecting these waypoints to the custom navigation path. This means that the user who created this custom navigation path intends to skip the course material referenced by preset waypoints “10 through 14” 212 and jump straight to Waypoint-55 214. From Waypoint-55 214 the custom navigation path goes directly to Waypoint-90 216. This custom navigation path is then stored as a custom profile.

In an embodiment a user, may create multiple custom profiles for a particular course. These custom profiles are then stored in the system and can be accessed by the user to change the profile at any time. The system manages all profiles storing the user's current progress within the particular course and all previous courses and respective profiles the user has completed.

### Machine Learning Customization

The system utilizes machine-learning techniques to suggest a profile for a student. In an embodiment the system determines the student's skills based on the student's completed courses and scores in those courses. For instance, if the system is determining a profile for the student for an Advanced Calculus course and the student's prior history shows that he completed and scored well in his previous Pre-Calculus and Calculus courses, then the system may suggest a profile that is set to playback introductory Advanced Calculus material at a low level of detail or skip portions of the introductory material altogether. Conversely, if the student scored poorly in his previous Pre-Calculus and Calculus courses then the system may suggest a profile that plays back the introductory material at a high level of detail and does not skip any material.

Machine-learning techniques are not limited to the student's scores in prior courses. The system may analyze the navigation paths used in prior courses to determine which type of course materials the student prefers. For instance, if the student in his previous courses regularly played all of the lecture materials, then the system may recommend a profile that includes all of the lectures materials without skipping any of them. Additionally, the system may determine that the student preferred to either skip most course materials related to problem sets or complete them at a relatively low level of detail. In this scenario, the system may suggest the minimal amount of problem sets for the student.

Other embodiments of machine-learning technology may utilize profiles used by past students of a particular course. In this case, the system may analyze the profiles completed by other students and their relative success with those profiles to suggest a successful profile for the student. By analyzing the past students' experience, completed courses, scores, and user preferences, the system may be able to determine which trends best fit the current student and suggest appropriate profiles for that student's needs.

Embodiments of the machine-learning technology are not limited to suggesting profiles for the student. The system may also be configured to automatically create and select a profile for the student by using the techniques discussed above. Additionally, machine-learning technology may be applied to determining which format course materials will be played. In this scenario, the system may utilize the playback preferences from prior courses taken by the student and prior preferences from past students to determine which format the student prefers.

### Playing a Course

The system utilizes the currently chosen profile by the user to navigate through the course without having to prompt the user for instruction. As discussed previously, a profile consists of a sequence of waypoints. During playback the system reads the profile and processes each waypoint in order to transverse through the course material as the user intended. For example, after the system has played a particular course material referenced by the first waypoint, the system then processes the second waypoint and begins playing the material referenced by the second waypoint.

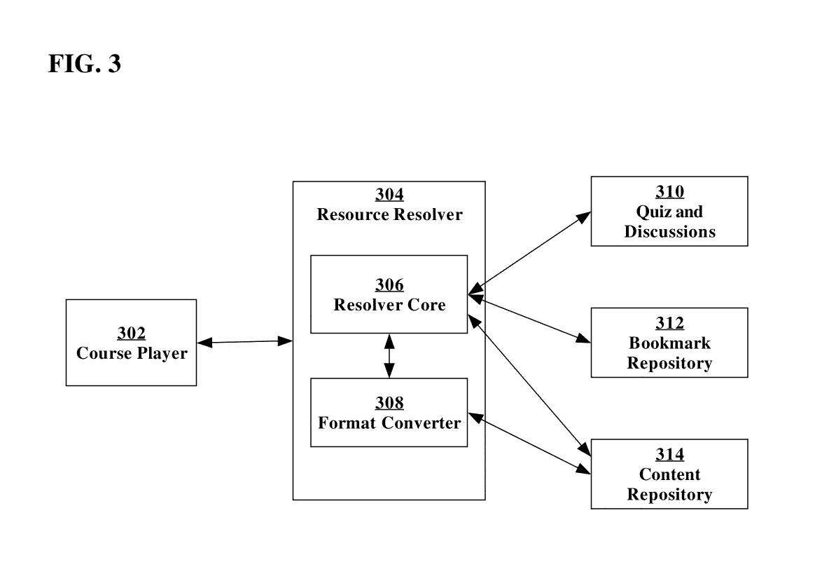

FIG. 3 is an embodiment of the system structure and the interaction between the different elements of the system. The Course Player 302 is a UI plugin, that sends the media player profile and the user's intended format to the Resource Resolver 304. The Course Player 302 plays the data received from the Resource Resolver 304.

The Resource Resolver 304 contains the Resolver Core 306 and the Format Converter 308. The Resolver Core 306 parses waypoint sequence information from the selected profile. The Resolver Core 306 then processes the current waypoint and determines which format to send to the Course Player 302. To determine which format to select, the Resolver Core 306 determines the available playable formats and the user's preferred format. The Resolver Core 306 then checks whether the Content Repository 314 contains the requested format. If the Content Repository 314 contains the requested format, then the Content Repository 314 returns the requested format to the Resolver Core 306, the Resource Resolver 304 then sends the data to the Course Player 302. If the Content Repository 314 does not contain the requested format for the particular course material, then the Resolver Core 306 sends the source and requested formats to the Format Converter 308, where the source format refers to the format stored in the Content Repository 314 and the requested format refers to the determined format for playback.

The Format Converter 308 then retrieves the source format from the Content Repository 314, and converts the source format to the requested format. The Format Converter 308 then stores the converted format in the Content Repository 314. The Content Repository 314 manages resource metadata on existing resources and communicates to the Resolver Core 306 and Format Converter 308 to help determine available formats for existing resources.

The Bookmark Repository 312 stores the current waypoint within the profile and the location within the currently played resource. This information is used for determining where to resume playback of the current resource.

The Course Player 302 is configured to receive contextual user inputs. These include, but are not limited to, speech recognition. The Course Player 302 is configured to accept speech commands for playback, such as pause, stop, or fast forward. Another use of contextual user input includes speech interacting with the course content itself. Here, the Course Player 302 sends to the user input to the Resource Resolver 304. The Resolver Core 306 receives the user input and converts the input into contextual input based on what the user is currently playing. For example, if the user talks to the Course Player 302 during a discussion exercise, the Resolver Core 306 converts the user's speech into text and inputs it into the discussion comments. If the Course Player 302 is playing a quiz, then the Resolver Core 306 converts the user's speech into a quiz answer. The Resolver Core 306 then sends the contextual user input to the appropriate Quiz and Discussion 310.

Embodiments of the system may also include dynamically altering the path provided by the profile when a particular requested format is unable to be played by the Course Player 302. For instance, if the waypoint references a Quiz that requires mouse input and the Course Player does not support mouse input, then the system may suggest to the user skipping this particular waypoint and coming back to it when mouse input is supported by the Course Player 302. Other embodiments of the system may automatically skip waypoints that are not supported at the time without prompting the user.

### Seamless Context Switching

The system is configured to support seamless context switching during the playback of course material. More specifically, the Course Player 302 remains context aware of the changing environments during playback. This enables the Course Player 302 to detect a context changes and send the context changes to the Resource Resolver 304. The Resolver Core 306 is able to dynamically request a different format and switch formats sent to the Course Player 302 during playback. For instance, if the Course Player 302 detects a 3G network connection and sends the current context to the Resource Resolver 304, then the Resource Resolver 304 may send the Course Player 302 audio/video for a given resource in Standard video format in order to ensure continuous playback. However, if during the playback the Course Player 302 detects a high speed WiFi connection and sends the updated context information to the Resource Resolver 304, then the Resolver Core 306 may request HD audio/video for the same resource. The Resource Resolver 304 would then seamlessly send the HD audio/video to the Course Player 302 instead of the Standard video. Another example of context switching includes the Course Player 302 detecting a different environment. For instance, the Course Player 302 may be playing course content on a smartphone in video format and then detects that the user is driving a car, then the system may prompt the user or automatically switch to a suitable context, such as audio only.

Another embodiment of context switching involves the Course Player 302 using predefined geo-locations, such as NFC tags, to determine which context to request. For instance, if the user has defined that when playback occurs in the kitchen the user prefers audio only, then the Course Player 302 would request an audio only preference for content when the Course Player 302 detects that the user is in the kitchen.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

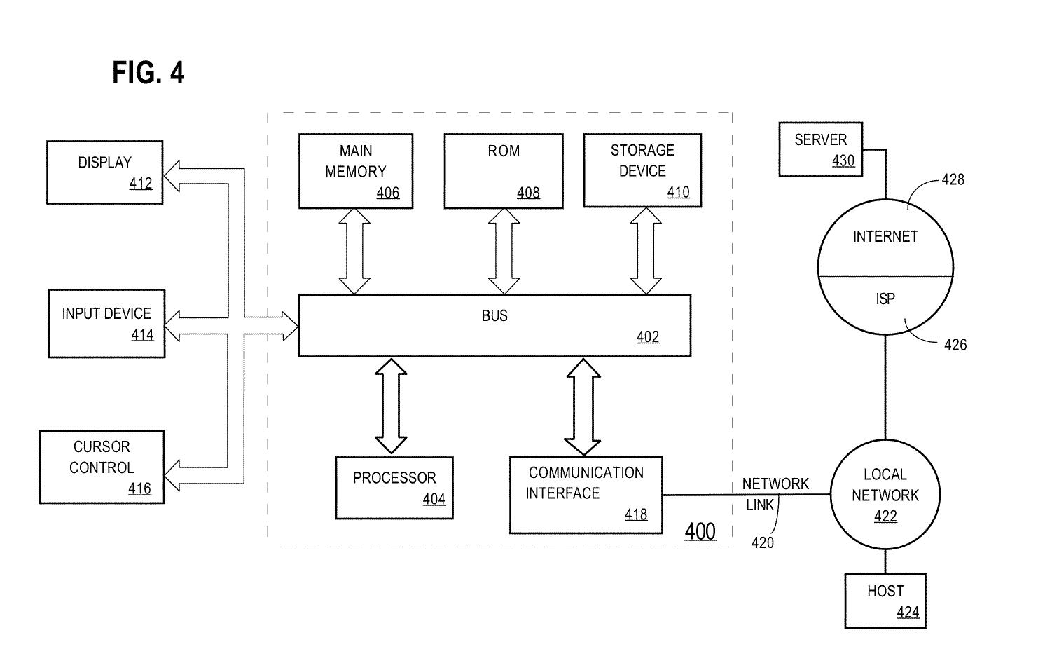

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
maintaining course material for a particular course, wherein:
the course material is divided into sections;
each section has a particular level of detail; and
the sections have been assigned a particular order;
creating a path through the course material by storing data that represents a sequence of waypoints, wherein each waypoint in the sequence of waypoints corresponds to a particular portion of the course material;
wherein the path does at least one of:
a) skips one or more portions of the course material,
b) specifies a presentation order for portions of the course material that differs from the particular order assigned to the sections, or
c) specifies presentation of at least a portion of the course material at a level of detail that differs from the particular level of detail of the section that corresponds to the portion;
wherein the method is performed by one or more computing devices.

2. The method of claim 1 wherein the path skips one or more portions of the course material.

3. The method of claim 1 wherein the path presents portions of the course material in a different order than the particular order assigned to the sections.

4. The method of claim 1 wherein the path presents at least a portion of the course material at a level of detail that differs from the particular level of detail of the section that corresponds to the portion.

5. The method of claim 1 wherein the path is created automatically based on output of a machine learning tool.

6. The method of claim 5 wherein the machine learning tool receives, as input, information about a specific user for which the path is being created.

7. The method of claim 6 wherein the information includes information about at least one of:
which courses the specific user has already taken; or
which skills the specific user has already mastered.

8. The method of claim 5 wherein:
the path is created for a specific user; and
the machine learning tool receives, as input, information about effectiveness of paths through the course that have been used previously by users other than the specific user.

9. The method of claim 1 wherein the step of creating a path is performed in response to receiving user input that specifies the sequence of waypoints.

10. The method of claim 4 wherein the level of detail at which the portion of the course material is presented is less than the level of detail of the section that corresponds to the portion.

11. The method of claim 4 wherein the level of detail at which the portion of the course material is presented is more than the level of detail of the section that corresponds to the portion.

12. A method comprising:
a course player receiving a path through course material for a particular course;
wherein the path includes data that represents a sequence of waypoints, wherein each waypoint in the sequence of waypoints corresponds to a particular portion of the course material; and
based on the path, the course player playing portions of the course material that correspond to the waypoints in the path in an order that is based on the sequence of the waypoints in the path.

13. The method of claim 12 wherein the path further includes data that specifies a level of detail for a particular waypoint that is different than a default level of detail of the course material.

14. A non-transitory computer readable medium storing instructions which, when executed by one or more processors, cause performance of a method comprising:
maintaining course material for a particular course, wherein:
the course material is divided into sections;
each section has a particular level of detail; and
the sections have been assigned a particular order;
creating a path through the course material by storing data that represents a sequence of waypoints, wherein each waypoint in the sequence of waypoints corresponds to a particular portion of the course material;
wherein the path does at least one of:
a) skips one or more portions of the course material,
b) specifies a presentation order for portions of the course material that differs from the particular order assigned to the sections, or
c) specifies presentation of at least a portion of the course material at a level of detail that differs from the particular level of detail of the section that corresponds to the portion;
wherein the method is performed by one or more computing devices.

15. The non-transitory computer readable medium of claim 14, wherein the path is created automatically based on output of a machine learning tool.

16. The non-transitory computer readable medium of claim 15, wherein the machine learning tool receives, as input, information about a specific user for which the path is being created.

17. The non-transitory computer readable medium of claim 16, wherein the information includes information about at least one of:
which courses the specific user has already taken; or
which skills the specific user has already mastered.

18. The non-transitory computer readable medium of claim 15, wherein:
the path is created for a specific user; and
the machine learning tool receives, as input, information about effectiveness of paths through the course that have been used previously by users other than the specific user.

19. A non-transitory computer readable medium storing instructions which, when executed by one or more processors, cause performance of a method comprising:
a course player receiving a path through course material for a particular course;
wherein the path includes data that represents a sequence of waypoints, wherein each waypoint in the sequence of waypoints corresponds to a particular portion of the course material; and
based on the path, the course player playing portions of the course material that correspond to the waypoints in the path in an order that is based on the sequence of the waypoints in the path.

20. The non-transitory computer readable medium of claim 19 wherein the path further includes data that specifies a level of detail for a particular waypoint that is different than a default level of detail of the course material.
